(19) United States
(12) Patent Application Publication
(10) Pub. No.: US 2015/0055957 A1
(43) Pub. Date: Feb. 26, 2015

(54) METHOD OF DETERMINING PHYSICAL LAYER WAVELENGTH OF TUNABLE OPTICAL NETWORK UNIT (ONU) IN TIME AND WAVELENGTH DIVISION MULTIPLEXED PASSIVE OPTICAL NETWORK (TWDM-PON)

(71) Applicant: ELECTRONICS AND TELECOMMUNICATIONS RESEARCH INSTITUTE, Daejeon-si (KR)

(72) Inventors: Han Hyub LEE, Daejeon-si (KR); Kwang Ok KIM, Jeonju-si (KR); Sang Soo LEE, Daejeon-si (KR)

(21) Appl. No.: 14/469,099

(22) Filed: Aug. 26, 2014

(30) Foreign Application Priority Data
Aug. 26, 2013 (KR) 10-2013-0100835
Nov. 4, 2013 (KR) 10-2013-0133176
Aug. 25, 2014 (KR) 10-2014-0110654

(51) Int. Cl. H04J 14/02; H04J 14/08

(52) U.S. Cl. CPC H04J 14/0227; H04J 14/08
USPC 398/79

(57) ABSTRACT

A method of determining a physical layer wavelength of a tunable optical network unit (ONU) in a time wavelength division multiplexing-passive optical network (TWDM-PON) is provided. First, a receiving wavelength of a tunable receiver is tuned to a downstream wavelength of one of a plurality of operable channels in a TWDM-PON system. Then, it is checked whether the tunable receiver maintains a state of loss of signal (LOS) for a predetermined period of time or the state of LOS is cleared. In response to a determination that the state of LOS is cleared, the ONU performs subsequent link establishment procedures in the channel, and in response to a determination that the state of LOS is maintained, the receiving wavelength of the tunable receiver is changed to a downstream wavelength of another channel.

### CROSS-REFERENCE TO RELATED APPLICATION(S)

This application claims priority from Korean Patent Application Nos. 10-2013-0100835, filed on Aug. 26, 2013, 10-2013-0133176, filed on Nov. 4, 2013, and 10-2014-0110654, filed on Aug. 25, 2014, in the Korean Intellectual Property Office, the disclosures of which are incorporated herein by references in its entirety.

### BACKGROUND

1. Field

The following description relates to a hybrid passive optical network (PON) that utilizes both time division multiplexing (TDM) mechanism and wavelength division multiplexing (WDM) mechanism, and more particularly, to a method of an optical network unit (ONU) to determine a wavelength of a tunable receiver in a passive optical network.

2. Description of the Related Art

A passive optical network (PON) is a subscriber network that connects a central office and a subscriber with a point-to-multipoint topology and is cost effective compared to a structure having a point-to-point topology since required central office systems and optical cables can be reduced.

A time division multiplexing-passive optical network (TDM-PON), for example, Ethernet EPON and Gigabit-Capable PON (GPON), uses one wavelength for upstream traffic and another wavelength for downstream traffic to connect a central office to subscribers, and is characterized by its use of, especially, an optical splitter which does not require power to establish a connection between the central office and the subscribers. Thanks to such characteristics, TDM-PON has been distributed worldwide and established successfully. Particularly, GPON networks have been established across the globe, especially in Northern America and Europe. In 2010, the International Telecommunication Union Telecommunication Standardization Sector (ITU-T) completed recommendation of G.987 XG-PON standard (10G-GPON). Recently, early commercial products based on the G.987 are being released. Furthermore, the Full Service Access Network (FSAN) Group, which is a standardization group consisting of major communication operators and equipment manufacturers associated with optical subscriber to network technology, adopted a time and wavelength division multiplexing passive optical network (TWDM-PON), which is a hybrid type passive optical network that uses time division multiplexing and wavelength division multiplexing at the same time, as major technology of a next-generation passive optical network (NG-PON2). Therefore, the ITU-T is discussing recommendation for G.ngpon2.x standards.

FIG. 1 is a diagram illustrating an optical subscriber network that can accommodate a plurality of different services, for example, TDM-PON (corresponding to GPON OLT and XGPON OLT in FIG. 1), p-to-p (corresponding to OTDR in FIG. 1), RF vide overlay (corresponding to RF VIDEO HE in FIG. 1), and the like. In the system configuration of FIG. 1, NG-PON2 (corresponding to NG-PON2 OLT port-1, . . . , and NG-PON2 OLT port-n in FIG. 1) is a hybrid network that uses TDM and WDM schemes. NG-PON2 with a structure capable of accommodating a plurality of same service links or different service links using a plurality of optical signals of different wavelengths can advantageously increase the transmission capabilities in proportion to the number of optical wavelength channels, without changing an optical distribution network used in the existing TDM network.

Referring to FIG. 1, a TWDM-PON network represented as NG-PON2 is a hybrid passive optical subscriber network that accommodates a central office system, including n optical line terminals (OLTs) that use different wavelengths. Under the assumption that each central office system accommodates one PON link, one optical distribution network accommodates n homogeneous or heterogeneous networks, and services are distinguished from each other by a wavelength band of a signal used. In this case, TWDM-PON optical network unit (ONU) (NG-PON2 ONU) receives wavelength-multiplexed downstream optical signals from a plurality of TWDM-PON OLTs. To communicate with a particular TWDM-PON OLT, the TWDM-PON ONU should be able to select a wavelength of an upstream signal corresponding to the particular TWDM-PON OLT. Thus, the ONU needs to be equipped with a wavelength-selectable transceiver, that is, a tunable transceiver. The tunable transceiver includes a tunable laser and a tunable receiver.

FIG. 2 is a conceptual diagram of TWDM-PON as a main technology of the next-generation passive optical subscriber network. In FIG. 2, it is assumed that there are n OLTs using different wavelengths, and each OLT accommodates one PON link. One optical distribution network accommodates n TDW-PON networks and TDM-PON links are distinguished from each other by a different wavelength used.

In the system of FIG. 2, one or more ONUs that use the same wavelength (λd1 for downstream transmission, λu1 for upstream transmission), for example, ONU A communicates with OLT #1 that uses the same wavelength, and in similar manner, ONU B may be connected to OLT #2. An upstream signal is transmitted to an OLT using a wavelength that matches with a downstream signal chosen by the ONU or a wavelength indicated by wavelength allocation information received from the OLT, and upstream signals transmitted from a plurality of ONUs are separated by wavelength by a demultiplexer, and resultant signals are transmitted to corresponding OLTs.

By contrast, since a downstream signal is multiplexed by a wavelength-multiplexer, each ONU receives all downstream wavelengths, and each ONU utilizes only light of a particular wavelength chosen from the received all downstream wavelengths. To this end, the ONU in a TWDM-PON system using a tunable receiver, that is, a tunable ONU, requires wavelength stabilization process or wavelength tuning process in a physical layer to synchronize a central frequency of a receiving signal of the chosen wavelength with a central frequency of a tunable filter within the tunable receiver. In other words, the tunable ONU may select an arbitrary wavelength chosen from wavelengths of downstream signals through which a service is being provided to the TWDM-PON system, and receive a downstream signal corresponding to the selected wavelength, and then, the ONU may be able to be activated based on the received downstream signal to establish a link to an OLT for communication.

In TWDM-PON system, it is possible to increase or decrease the number of currently operating channels, that is, the number of pairs of downstream wavelength and upstream wavelength for channel load balancing or efficient system management. For example, the TWDM-PON may use all four channels when there are many service users, but when the number of service users decreases or the needed traffic capacity is reduced, it may be possible to reduce the number of channels in use for efficient system operation.

FIG. 3 is a diagram schematically illustrating a relevant scenario. Referring to FIG. 3, at normal stage, a service is provided through downstream wavelengths λ1, λ2, λ3, . . . , and λn of all channels, while at power saving stage, downstream wavelengths λ2, λ3, . . . , and λn of some channels stop being used, and the service is provided through only the downstream wavelength λ1 of the remaining channel. Therefore, by shutting the power to the optical transceivers of OLTs (corresponding to NG-PON2 OLT Port-2, NG-PON2 OLT2 OLT Port-3, . . . , and NG-PON2 OLT Port-n in FIG. 3) for unused channels, the power consumption by the system can be reduced.

In another example, a communication service provider that offers Internet services using TWDM-PON may initially operate one channel, for the sake of reducing system operation costs, and increase the number of operating channels in phases. FIG. 4 is a diagram schematically illustrating a relevant scenario. Referring to FIG. 4, a service is provided through one downstream wavelength channel λ1 at an initial stage, then is provided through two downstream wavelength channels λ1 and λ2 at an intermediate stage, and finally is provided through all downstream wavelength channels λ2, λ3, . . . , and Xn at a final stage.

As described above, in a case where the number of operating channels varies over time, an ONU intending to establish a link to the ONU or OLT that is installed in the TWDM-PON system for the first time is not able to retain information of a channel (wavelength) that is currently used in the system, and thus needs to search all channels, that is, all downstream wavelengths, which are operable in the system. In this case, the ONU has to search even unused downstream wavelength channels, and thus a relatively longer search time is required. In addition, since the ONU needs to determine a channel to be used by selecting one from currently available channels based on the search result and perform activation process through the determined channel to establish a link to an OLT, a link establishment time may be increased.

### SUMMARY

An objective to be solved by the present invention is to provide a method for determining a physical layer wavelength, whereby an optical network unit (ONU) equipped with a tunable receiver is enabled to effectively select an available channel, i.e., a downstream wavelength in a system, such as a TWDM-PON system, in which multiple channels can be operated.

According to exemplary embodiments, a tunable ONU of a TWDM-PON system performs wavelength tuning process, including a communication procedure between a medium access control (MAC) part and a wavelength-tunable receiver. Particularly, the MAC part selects a wavelength based on LOS result transmitted from the wavelength-tunable receiver (i.e., a physical layer), so that it can quickly find an available downstream wavelength that is currently operating in the system, and then proceeds to an ONU activation procedure.

According to an exemplary embodiment, there is provided a method of determining a physical layer wavelength of an optical network unit (ONU), as a part of activation of the ONU equipped with a tunable receiver in a time wavelength division multiplexing-passive optical network (TWDM-PON) system having a plurality of operable channels, the method including operations of (a) tuning a receiving wavelength of the tunable receiver to a downstream wavelength of a first channel belonging to the plurality of operable channels of the TWDM-PON system; (b) checking whether the tunable receiver maintains a state of loss of signal (LOS) for a predetermined period of time after operation (a) or the state of LOS is cleared; and (c) in response to a determination that the state of LOS of the tunable receiver is cleared, performing subsequent link establishment procedures in the first channel.

In one aspect of the exemplary embodiment, the method may further include an operation of (d) in response to a determination made in (c) that the tunable receiver maintains the state of LOS, changing the receiving wavelength of the tunable receiver to a downstream wavelength of a second channel belonging to the plurality of operable channels. In addition, the method may further include, after (d), operations of: (e) checking whether the tunable receiver maintains a state of LOS for a predetermined period of time or the state of LOS is cleared after the receiving wavelength of the tunable receiver has changed to the second channel; and (f) in response to a determination made in the operation of (e) that the tunable receiver maintains the state of LOS, changing the receiving wavelength of the tunable receiver to a downstream wavelength of a third channel belonging to the plurality of operable channels.

In another aspect of the exemplary embodiment, the ONU may be in one of states of a first downstream ONU synchronization state machine that includes a hunt state, a pre-sync state, a sync state, and a re-sync state, the ONU may enter into the hunt state in response to a determination made in the operation of (b) that the state of LOS of the tunable receiver is cleared, and then ONU may be changed to the pre-sync state from the hunt state if physical synchronization and super frame counter are available while the ONU is in the hunt state. In this case, the first downstream ONU synchronization state machine may further include a channel state to check whether the state of LOS of the tunable receiver is maintained or cleared, and a channel shift state to change a channel of the tunable receiver to another channel when the state of LOS is maintained while the ONU is in the channel state. Alternatively, the first downstream ONU synchronization state machine may further include a channel stabilization state between the channel state and the channel shift state.

In yet another aspect of the exemplary embodiment, the ONU may be in one of states of a second downstream ONU synchronization state machine that includes a hunt state, a tuning state, and a locking state.

In still another aspect of the exemplary embodiment, the ONU may be in one of states of a third downstream ONU synchronization state machine that includes a hunt state, a tuning state, a stabilization state, and a locking state.

According to another exemplary embodiment, there is provided an optical network unit (ONU) for supporting determination of a physical layer wavelength for link establishment in a time wavelength division multiplexing-passive optical network (TWDM-PON) system having a plurality of operable channels, the ONU including a tunable receiver and being configured to tune a receiving wavelength of the tunable receiver to a downstream wavelength of a first channel belonging to the plurality of operable channels, to check whether the tunable receiver maintains a state of LOS for a predetermined period of time or the state of LOS is cleared, and to perform subsequent link establishment procedures in the first channel in response to a determination that the state of LOS of the tunable ONU is cleared.

In one aspect of the exemplary embodiment, the ONU may be configured, in response to a determination that the tunable receiver maintains the state of LOS, to change the receiving wavelength of the tunable receiver to a downstream wavelength of a second channel belonging to the plurality of operable channels. In this case, the ONU may be configured to check whether the tunable receiver maintains a state of LOS for a predetermined period of time or the state of LOS is cleared after the receiving wavelength of the tunable receiver has changed to the second channel; and in response to a determination that the tunable receiver maintains the state of LOS, change the receiving wavelength of the tunable receiver to a downstream wavelength of a third channel belonging to the plurality of operable channels. In addition, the ONU may be configured, in response to a determination that the state of LOS of the tunable receiver is cleared, to perform subsequent link establishment procedures in the second channel.

In yet another aspect of the exemplary embodiment, the ONU may be configured: to be in one of states of a first downstream ONU synchronization state machine that includes hunt state, pre-sync state, a sync state, and re-sync state; and enter into the hunt state in response to a determination that the state of LOS of the tunable receiver is cleared, and then to change to the pre-sync state from the hunt state if physical synchronization and super frame counter are available while the ONU is in the hunt state. In this case, the first downstream ONU synchronization state machine may further include a channel state to check whether the state of LOS of the tunable receiver is maintained or cleared, and a channel shift state to change a channel of the tunable receiver to another channel when the state of LOS is maintained while the ONU is in the channel state. In addition, the first downstream ONU synchronization state machine may further include a channel stabilization state between the channel state and the channel shift state.

In still another aspect of the exemplary embodiment, the ONU may be configured to be in one of states of a second downstream ONU synchronization state machine that includes a hunt state, a tuning state, and a locking state.

In yet another aspect of the exemplary embodiment, the ONU may be configured to be in one of states of a third downstream ONU synchronization state machine that includes a hunt state, a tuning state, a stabilization state, and a locking state.

Other features and aspects will be apparent from the following detailed description, the drawings, and the claims.

### BRIEF DESCRIPTION OF THE DRAWINGS

FIG. 1 is a diagram illustrating an optical subscriber network that can accommodate a plurality of different services by applying wavelength multiplexing scheme to an existing passive optical subscriber network.

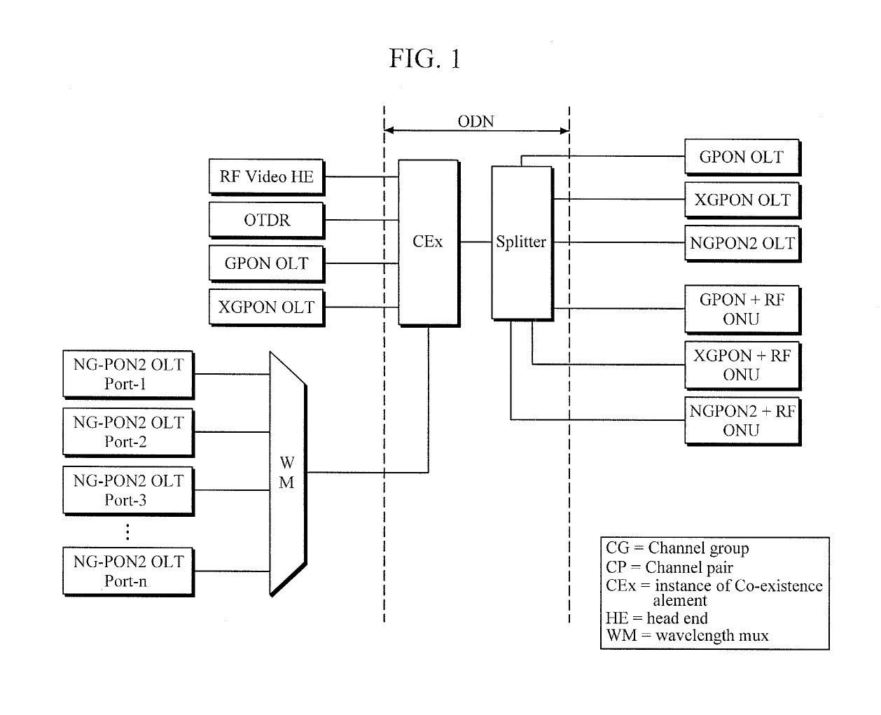

FIG. 2 is a diagram illustrating a time wavelength division multiplexing-passive optical network (TWDM-PON) system.

FIG. 3 is a diagram illustrating an example of a scenario of reducing the number of channels used in a TWDM-PON system over time.

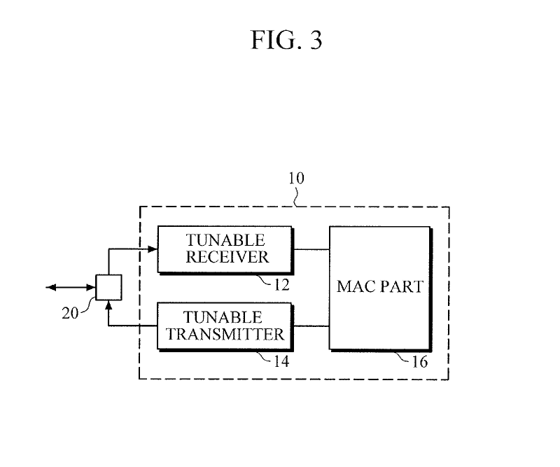

FIG. 4 is a diagram illustrating an example of a scenario of increasing the number of channels used in a TWDM-PON system over time.

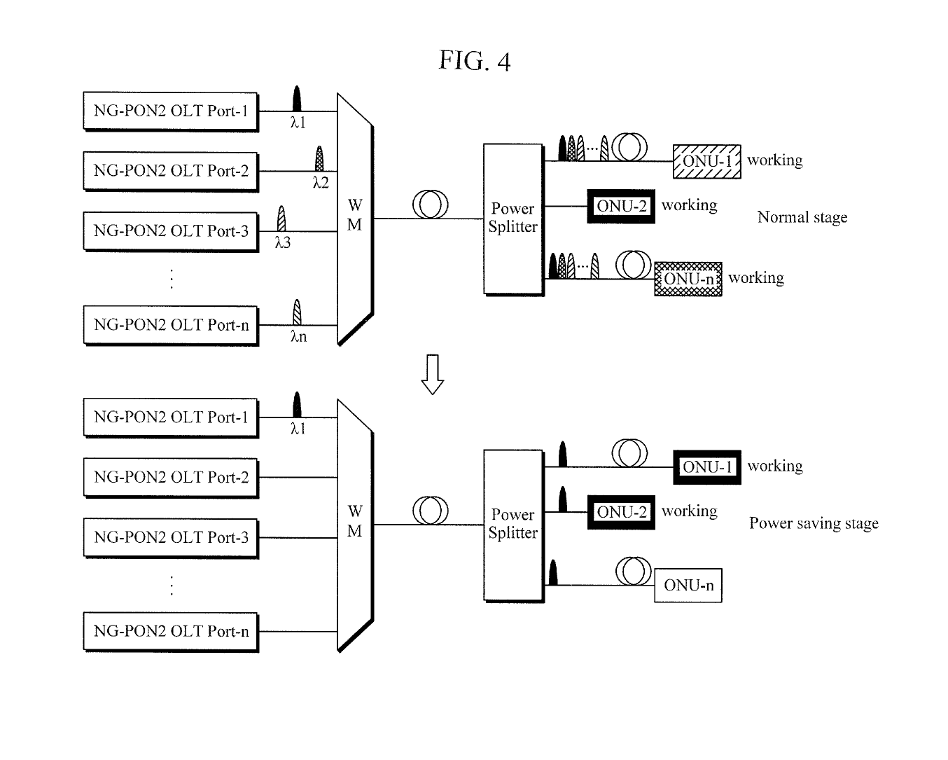

FIG. 5 is a diagram illustrating a schematic configuration of an optical network unit (ONU) having a tunable transceiver, which is included in the TWDM-PON system shown in FIG. 2.

FIG. 6 is a flowchart illustrating a method for determining a physical layer wavelength of a tunable ONU in a TWDM-PON according to an exemplary embodiment.

FIG. 7 is a diagram illustrating states in an initial stage of an activation process of an ONU in an existing TDM-PON, which may also be referred to as a downstream ONU synchronization state machine.

FIG. 8 is a diagram illustrating an example of a downstream ONU synchronization state machine to which a wavelength determination method according to an exemplary embodiment is applied.

FIG. 9 is a diagram illustrating another example of a downstream ONU synchronization state machine to which a wavelength determining method according to an exemplary embodiment is applied.

FIG. 10 is a diagram illustrating another example of a downstream ONU synchronization state machine to which a wavelength determining method according to an exemplary embodiment is applied.

FIG. 11 is a diagram illustrating another example of a downstream synchronization state machine to which a wavelength determining method according to an exemplary embodiment is applied.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

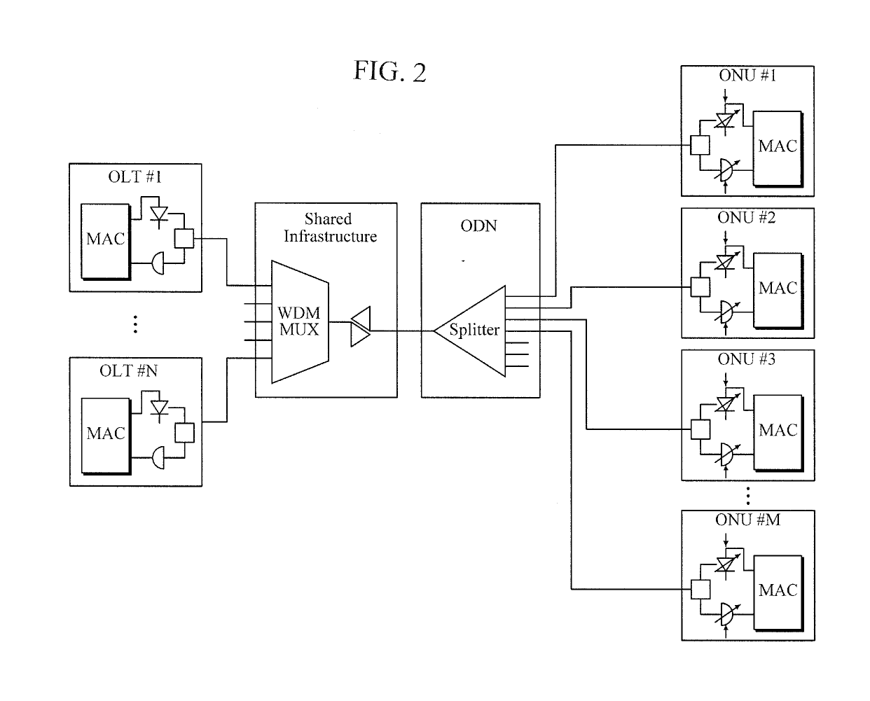

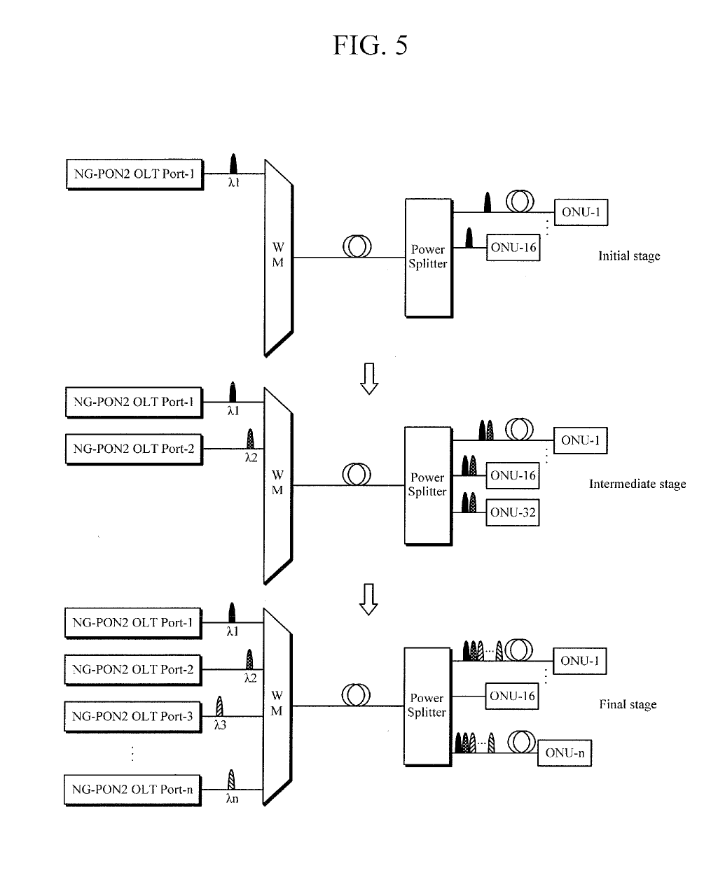

FIG. 5 is a diagram illustrating a schematic configuration of an optical network unit (ONU) having a tunable transceiver, which is included in a time wavelength division multiplexing (TWDM)-passive optical network (PON) system shown in FIG. 2. Hereinafter, an optical network unit (ONU) that includes at least a tunable receiver will be collectively referred to as a “tunable ONU”. The tunable ONU may have a tunable transceiver, as well as a tunable receiver.

Referring to FIG. 5, a tunable ONU 10 includes a tunable receiver 12, a tunable transmitter 14, and a medium access control (MAC) part 16. Generally, the tunable ONU 10 may be connected to an optical distribution network (ODN) (refer to FIG. 2) via a wavelength division multiplexing (WDM) filter 20. The MAC part 16 of the tunable ONU 10 may be an electronic circuit part to process transmitted and received optical signals.

Referring to FIGS. 2 and 5, the tunable transmitter 14 transmits an upstream signal of a selected or allocated wavelength to an optical line terminal (OLT) via the ODN. The MAC part 16 may control a transmission wavelength of the tunable transmitter 14 through a predetermined signal. Then, the MAC part 16 may control a wavelength of an upstream signal by the tunable transmitter 14 to correspond to a wavelength of the downstream signal received by the tunable receiver 12. In this case, since each of the ONUs of the TWDM-PON system uses an upstream signal that corresponds to a wavelength of its own downstream signal, or an upstream signal of a wavelength allocated by the OLT, the upstream signal from the each ONU is split according to wavelength by a demultiplexer, which is not explicitly shown in FIG. 2, but is still a part of a shared infrastructure, and then each split signal is transmitted to corresponding OLT.

The downstream signal is multiplexed by a wavelength multiplexer, so that downstream signals of all wavelengths that have passed through the WDM filter 20 can reach each ONU. Then, the ONU 10 may receive a particular wavelength among all downstream wavelengths of light, and more specifically, an optical signal in a particular wavelength band, through the tunable receiver 12. The receiving wavelength band may vary with time. According to the exemplary embodiment, a technique of the tunable receiver 12 to change a receiving wavelength may not be limited. For example, the tunable receiver 12 may adjust a pass wavelength band using physical filter shift by voltage value control or current value control, or by changing thermal refractive index through temperature control.

The MAC part 16 may receive the downstream signal through the tunable receiver 12 and process the signal. In one example, in a case where the tunable ONU 10 is installed in the TWDM-PON system for the first time, or a currently using channel is changed to another channel, the MAC part 16 may choose a channel to perform the subsequent link establishment procedures based on a state of loss of signal (LOS) delivered from the tunable receiver 12. Here, based on a “state of loss of signal (LOS)” whether or not an optical signal is received through the tunable receiver 12 is identified. For example, the state of LOS may indicate that an optical signal is not received, and the clearing of the state of LOS may indicate that a signal is received, or vice versa, but aspects of the present disclosure are not limited thereto.

As described above, in the TWDM-PON system, all operable channels or only some are used. In addition, different channels may be used over time. In this case, if the tunable ONU 10 is installed for the first time in the TWDM-PON system or intends to change the current channel to another, the tunable ONU 10 cannot identify whether the channel intended to be connected is available or not. In one example, whether the channel of interest is in use or not is determined based on the state of LOS, so that the tunable ONU 10 can promptly determine whether the channel of interest is available for the subsequent link establishment procedures or the channel is required to be changed to another channel.

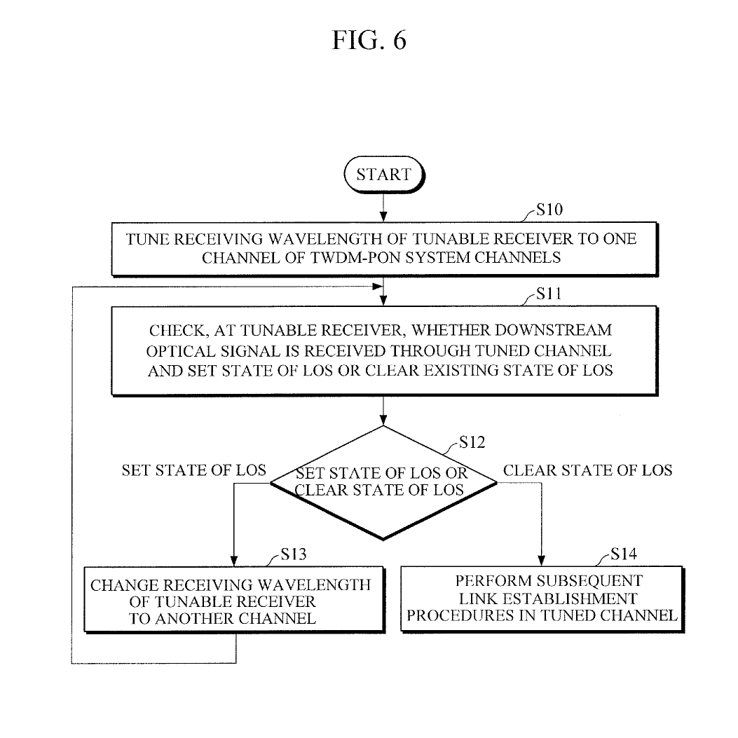

FIG. 6 is a flowchart illustrating a method for determining a physical layer wavelength of a tunable ONU in a TWDM-PON according to an exemplary embodiment. The tunable ONU may be an ONU that is installed in the TWDM-PON system for the first time, or an ONU that intends to change a previous channel to another channel.

Referring to FIG. 6, the tunable ONU may tune a receiving wavelength of a tunable receiver to one of TWDM-PON system channels in S10. Here, the “TWDM-PON system channels” refer to all channels operable in a corresponding system, and include non-operated channels which may be operated in the future (i.e., channels available for service according to system specifications), as well as currently operating channels.

In addition, the tunable receiver checks whether a downstream optical signal is received through the tuned channel, that is, a wavelength of a downstream signal, and sets a state of LOS or clear a set state of LOS in S11. For example, if receiving a downstream optical signal through the tuned channel, the tunable receiver may clear the state of LOS, and otherwise, may set the state of LOS. The result of the check as to whether the state of LOS is set or cleared is transmitted from the tunable receiver to the MAC part.

In S12, the MAC part determines whether the corresponding channel is in a state of LOS or released from the state of LOS based on the signal transmitted from the tunable receiver. If a determination is made in S12 that the channel is in a state of LOS, it indicates that the tunable receiver has failed to receive the downstream signal through the channel, and thus it is determined that the channel is not currently operating in the TWDM-PON system, and the receiving wavelength of the tunable receiver is, hence, changed to another channel in S13. With respect to the changed channel, operation S11 and the subsequent operations are repeated.

If a determination is made in S12 that the corresponding channel is released from the state of LOS, it indicates that the tunable receiver has received a downstream signal through the channel, and thus it is determined that the channel is currently operating in the TWDM-PON system, and the tunable ONU performs the subsequent link establishment procedure through the channel. As a result, the tunable ONU is enabled to determine a physical layer wavelength to a wavelength of a channel released from the state of LOS among the TWDM-PON system channels.

A method of a tunable ONU to determine a physical layer wavelength in a TWDM-PON according to an exemplary embodiment is described in conjunction with a downstream ONU synchronization state machine.

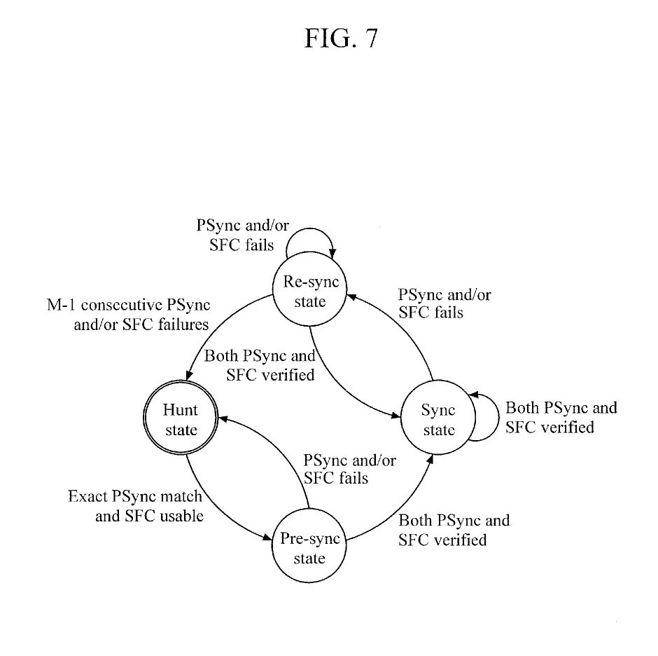

FIG. 7 is a diagram illustrating states in an initial stage of an activation process of an ONU in an existing TDM-PON, which may also be referred to as a downstream ONU synchronization state machine.

Referring to FIG. 7, an ONU may be in one of hunt state, pre-sync state, sync state, and re-sync state. In hunt state, physical synchronization and/or super frame counter (SFC) are not available. An ONU in hunt state may be able to carry out exact physical synchronization match and if the super frame counter becomes available, the ONU may be changed to pre-sync state. The ONU in pre-sync state is changed to sync state in response to the super frame counter being authenticated, and yet may return to hunt state if the physical synchronization and/or super frame counter fails to perform. The ONU in sync state periodically performs authentication for the physical synchronization and super frame counter, and if the authentication fails, may be changed to re-sync state. The ONU in re-sync state may reattempt authentication for the physical synchronization and super frame counter, and if the authentication is successful, the ONU returns to sync state. If the authentication successively fails more than a predefined number of times (M−1, M is an integer equal to or greater than 2), the ONU may return to hunt state.

As such, the ONU in hunt state receives a downstream signal and then attempts frame synchronization to frames of the received downstream signal. In response to the completion of frame synchronization, the ONU enters into pre-sync state. Prior to hunt state, the state of LOS is continuously checked to determine the presence or absence of a downstream signal. If the state of LOS is not removed within a predetermined period of time, the ONU remains in the same state. That is, the ONU does not perform any operation.

If a state machine as described in FIG. 7 is applied to a TWDM-PON ONU, namely, a tunable ONU, the ONU selects a channel that is not currently operated by the TWDM-PON system, and attempts to activate the channel, the ONU may fail to be activated. For example, among wavelengths λ1 to λ4 of a downstream signal available in the TWDM-PON system, only λ1 may be currently operated. In this example, if an ONU that is newly installed in the system or has been connected through a different wavelength selects wavelength λ2 and attempts to activate or connect to wavelength λ2, the ONU does not perform any operation since state of LOS has not been cleared. Therefore, the ONU requires a function to explore only downstream wavelength signals and currently operated channels while excluding the channels or downstream wavelengths that are not currently operated in the system.

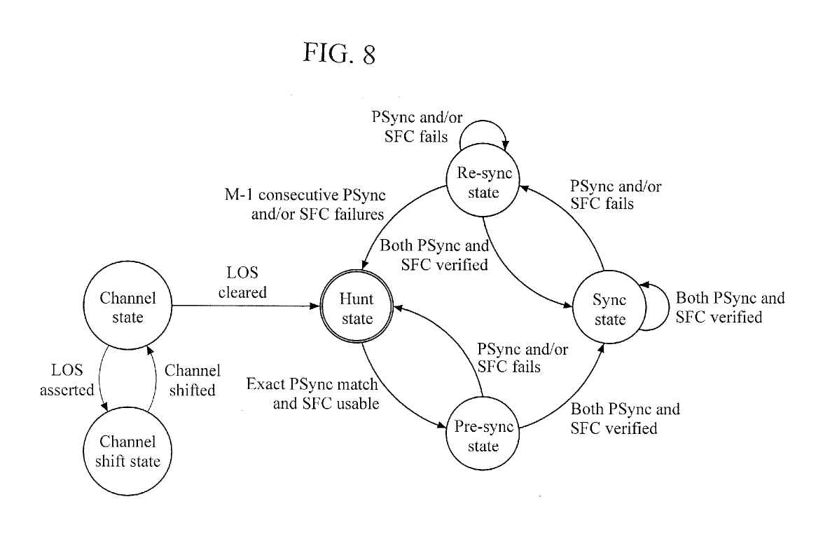

FIG. 8 is a diagram illustrating an example of a downstream ONU synchronization state machine to which a wavelength determination method according to an exemplary embodiment is applied. Herein, the example of FIG. 8 is described focusing on differences from FIG. 7, and the descriptions provided with reference to FIG. 7 may be applied to descriptions, which will be omitted hereinafter.

Referring to FIG. 8, the downstream ONU synchronization state machine includes channel state preceding hunt state, and channel state is linked to channel shift state. Therefore, a tunable ONU enters into channel state when choosing an arbitrary downstream signal, and if state of LOS is cleared within a predetermined period of time, the tunable ONU is changed to hunt state. In this case, the predetermined period of time may be set by a system operator without limitation, and generally 100 ms is suitable.

If the state of LOS fails to be cleared within the predetermined period of time, the tunable ONU is changed to channel shift state. The tunable ONU in channel shift state changes a receiving wavelength of a tunable receiver. Then, the tunable ONU having the changed receiving wavelength returns to channel state, and then remains on standby for a predefined time. If the state of LOS is cleared after the tunable ONU changed the receiving wavelength and has returned to channel state, the tunable ONU is changed to hunt state, but even when the tunable ONU has returned to channel state after changing the receiving wavelength, if the state of LOS fails to be cleared, the ONU goes back to channel shift state.

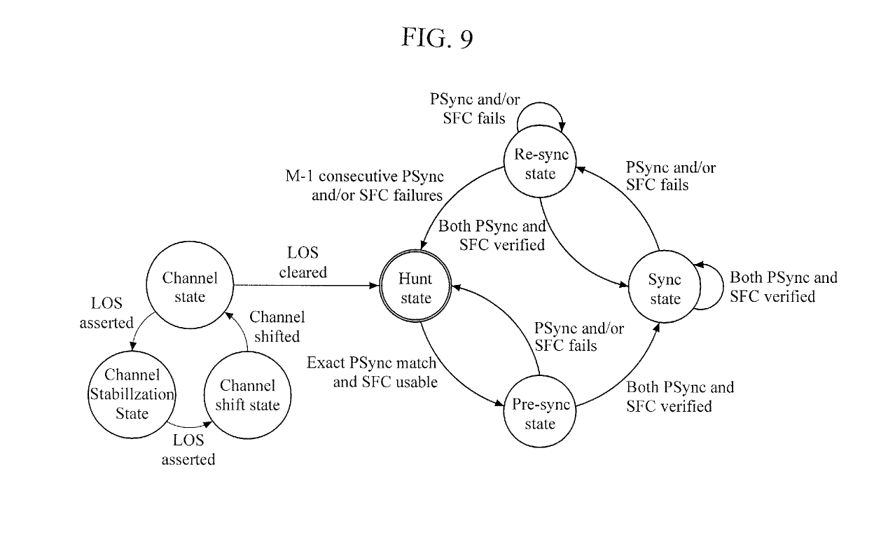

FIG. 9 is a diagram illustrating another example of a downstream ONU synchronization state machine to which a wavelength determining method according to an exemplary embodiment is applied. Herein, the example of FIG. 9 is described focusing on differences from FIG. 7, and the descriptions provided with reference to FIG. 7 may be applied to descriptions which will be omitted hereinafter.

Referring to FIG. 9, the downstream ONU synchronization state machine includes channel state preceding hunt state, and channel state is linked to channel stabilization state. The ONU in channel stabilization state attempts to stabilize a receiving wavelength of a tunable receiver. After stabilization of the receiving wavelength, the ONU is changed to channel state, and if a state of LOS is cleared within a predetermined period of time, the tunable ONU is changed to hunt state. In this case, the predetermined period of time may be set by a system operator without limitation, and generally 100 ms is suitable.

However, if the state of LOS fails to be cleared within the predetermined period of time, the tunable ONU is changed to channel shift state. The ONU in channel shift state changes a receiving wavelength of the tunable receiver. Then, the tunable ONU, having the changed receiving wavelength, returns to channel state and attempts to stabilize the receiving wavelength while being in channel stabilization state linked to the channel state. If the state of LOS is cleared after the tunable ONU attempts the stabilization of the receiving wavelength, the tunable ONU is changed to hunt state. However, when the state of LOS fails to be cleared despite the attempt to stabilize the receiving wavelength, the tunable ONU returns back to channel shift state.

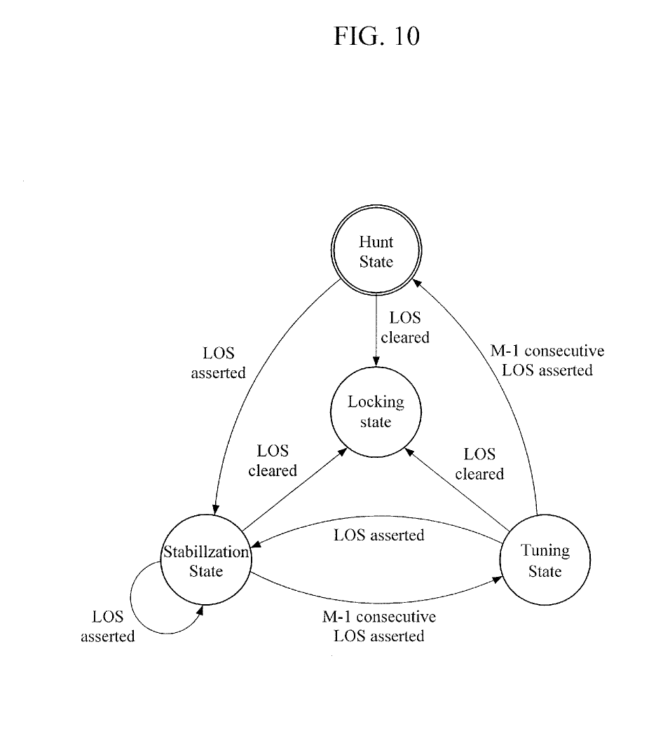

FIG. 10 is a diagram illustrating another example of a downstream ONU synchronization state machine to which a wavelength determining method according to an exemplary embodiment is applied. The downstream ONU synchronization state machine of FIG. 10 differs from the above state machines in that it relates to procedures of a tunable ONU to discover an operating wavelength when the tunable ONU is newly installed in the TWDM-PON system or changes from power-saving mode to operating mode.

Referring to FIG. 10, the state machine includes four states: hunt state; stabilization state, tuning state, and locking state. The reason the state machine includes a stabilization state is that the tunable ONU is able to use an untuned tunable receiver. A wavelength of the tunable receiver may, thus, not fall at the central frequency of a downstream wavelength channel. The stabilization state is used in an effort to minimize the wavelength mismatch between a wavelength of the receiver (Rx) and the downstream wavelength channel. Any ONU self-calibration method may be used without limitation, and for example, online ONU wavelength adjusting procedures may be utilized.

The tunable ONU may begin with hunt state among the above four states. In the initial stage, i.e., in hunt state, the ONU may be prepared to clear a state of LOS without tuning a receiver. Then, the tunable ONU starts an LOS timer (T0xx). The LOS timer T0xx limits a time for which the tunable ONU remains in hunt state, stabilization state, or tuning state, and thus the LOS timer T0xx is used to assert a failure of the ONU to restore from an LOS condition. A value of the LOS timer (T0xx) is not limited and may be appropriately set in consideration of the requirements of the system.

By setting the number of times to operate the LOS timer to two or more, it becomes possible to re-confirm the assertion of failure. This is to prevent a possible LOS detection error of the tunable receiver. This operation may be applied to other states.

If the state of LOS is not cleared until the LOS timer (T0xx) has expired, the tunable ONU is shifted to stabilization state and performs self-channel calibration. Then the tunable ONU starts the LOS timer T0xx. If the state of LOS is not cleared until the LOS timer (T0xx) has expired, the tunable ONU is shifted to tuning state, and then tunes a wavelength of the tunable receiver. The order of wavelength tuning is not limited, and, for example, the wavelength tuning may be carried out in an arbitrary order or by scheduled round robin. Thereafter, the tunable ONU starts the LOS timer (T0xx). If the state of LOS is not cleared until the LOS timer has expired, the ONU returns to stabilization state.

If the state of LOS is cleared while the tunable ONU is in tuning state, the tunable ONU is changed to locking state. If the consecutive M−1 states of LOS are asserted, the tunable ONU may declare the loss of downstream wavelength channel discovery, and be changed to hunt state. Then, if the state of LOS is cleared while the ONU is in stabilization state, the tunable ONU is changed to locking state. However, if consecutive M−1 states of LOS are asserted, the tunable ONU is changed to hunt state. In addition, the tunable ONU in locking state attempts frame synchronization with a downstream signal.

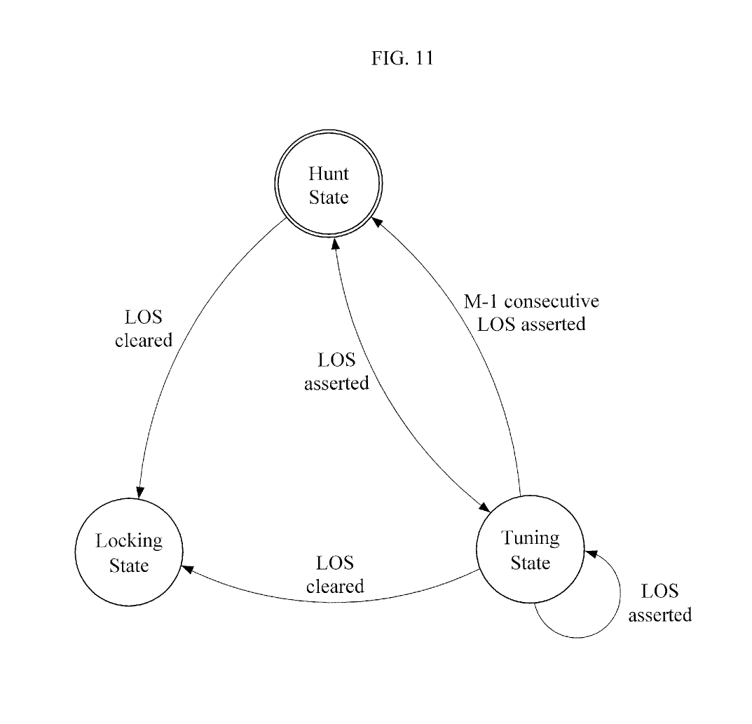

FIG. 11 is a diagram illustrating another example of a downstream synchronization state machine to which a wavelength determining method according to an exemplary embodiment is applied. The downstream ONU synchronization state machine of FIG. 11 differs from the state machines of FIGS. 7 to 9 in that it relates to procedures of a tunable ONU to discover an operating wavelength when the tunable ONU is newly installed in the TWDM-PON system or changed from power-saving mode to operating mode. In addition, the state machine of FIG. 11 is different from the state machine of FIG. 10 in that it does not include stabilization state. Therefore, descriptions provided with reference to FIG. 10 may be applied to descriptions which will be omitted hereinafter.

Referring to FIG. 11, if a state of LOS is cleared while a tunable ONU is in hunt state, the tunable ONU is changed to locking state. Conversely, if the state of LOS is asserted while the tunable ONU is in hunt state, then the ONU is changed to tuning state. If consecutive M−1 states of LOS are asserted while the ONU is in tuning state, the ONU goes back to hunt state. However, if the state of LOS is cleared while the ONU is in tuning state, the ONU is transited to locking state.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of determining a physical layer wavelength of an optical network unit (ONU), as a part of activation of the ONU equipped with a tunable receiver in a time wavelength division multiplexing-passive optical network (TWDM-PON) system having a plurality of operable channels, the method comprising operations of:
(a) tuning a receiving wavelength of the tunable receiver to a downstream wavelength of a first channel belonging to the plurality of operable channels of the TWDM-PON system;
(b) checking whether the tunable receiver maintains a state of loss of signal (LOS) for a predetermined period of time after operation (a) or the state of LOS is cleared; and
(c) in response to a determination that the state of LOS of the tunable receiver is cleared, performing subsequent link establishment procedures in the first channel.

2. The method of claim 1, further comprising an operation of:
(d) in response to a determination made in (c) that the tunable receiver maintains the state of LOS, changing the receiving wavelength of the tunable receiver to a downstream wavelength of a second channel belonging to the plurality of operable channels.

3. The method of claim 2, further comprising, after (d), operations of:
(e) checking whether the tunable receiver maintains a state of LOS for a predetermined period of time or the state of LOS is cleared after the receiving wavelength of the tunable receiver has changed to the second channel; and
(f) in response to a determination made in (e) that the tunable receiver maintains the state of LOS, changing the receiving wavelength of the tunable receiver to a downstream wavelength of a third channel belonging to the plurality of operable channels.

4. The method of claim 3, wherein the operation of (f) comprises performing subsequent link establishment procedures in the second channel in response to a determination that the state of LOS of the tunable receiver is cleared.

5. The method of claim 1, wherein the ONU is in one of states of a first downstream ONU synchronization state machine that includes a hunt state, a pre-sync state, a sync state, and a re-sync state, the ONU enters into the hunt state in response to a determination made in the operation of (b) that the state of LOS of the tunable receiver is cleared, and then ONU is changed to the pre-sync state from the hunt state if physical synchronization and super frame counter are available while the ONU is in the hunt state.

6. The method of claim 5, wherein the first downstream ONU synchronization state machine further includes a channel state to check whether the state of LOS of the tunable receiver is maintained or cleared, and a channel shift state to change a channel of the tunable receiver to another channel when the state of LOS is maintained while the ONU is in the channel state.

7. The method of claim 6, wherein the first downstream ONU synchronization state machine further includes a channel stabilization state between the channel state and the channel shift state.

8. The method of claim 1, wherein the ONU is in one of states of a second downstream ONU synchronization state machine that includes a hunt state, a tuning state, and a locking state.

9. The method of claim 1, wherein the ONU is in one of states of a third downstream ONU synchronization state machine that includes a hunt state, a tuning state, a stabilization state, and a locking state.

10. An optical network unit (ONU) for supporting determination of a physical layer wavelength for link establishment in a time wavelength division multiplexing-passive optical network (TWDM-PON) system having a plurality of operable channels, the ONU comprising a tunable receiver and being configured to tune a receiving wavelength of the tunable receiver to a downstream wavelength of a first channel belonging to the plurality of operable channels, to check whether the tunable receiver maintains a state of LOS for a predetermined period of time or the state of LOS is cleared, and to perform subsequent link establishment procedures in the first channel in response to a determination that the state of LOS of the tunable ONU is cleared.

11. The ONU of claim 10, being configured to, in response to a determination that the tunable receiver maintains the state of LOS, change the receiving wavelength of the tunable receiver to a downstream wavelength of a second channel belonging to the plurality of operable channels.

12. The ONU of claim 11, being configured to:
check whether the tunable receiver maintains a state of LOS for a predetermined period of time or the state of LOS is cleared after the receiving wavelength of the tunable receiver has changed to the second channel; and
in response to a determination that the tunable receiver maintains the state of LOS, change the receiving wavelength of the tunable receiver to a downstream wavelength of a third channel belonging to the plurality of operable channels.

13. The ONU of claim 12, being configured to, in response to a determination that the state of LOS of the tunable receiver is cleared, perform subsequent link establishment procedures in the second channel.

14. The ONU of claim 10, being configured to:
be in one of states of a first downstream ONU synchronization state machine that includes hunt state, pre-sync state, a sync state, and re-sync state; and
enter into the hunt state in response to a determination that the state of LOS of the tunable receiver is cleared, and then change to the pre-synch state from the hunt state if physical synchronization and super frame counter are available while the ONU is in the hunt state.

15. The ONU of claim 14, wherein the first downstream ONU synchronization state machine further includes a channel state to check whether the state of LOS of the tunable receiver is maintained or cleared, and a channel shift state to change a channel of the tunable receiver to another channel when the state of LOS is maintained while the ONU is in the channel state.

16. The ONU of claim 15, wherein the first downstream ONU synchronization state machine further includes a channel stabilization state between the channel state and the channel shift state.

17. The ONU of claim 10, being configured to be in one of states of a second downstream ONU synchronization state machine that includes a hunt state, a tuning state, and a locking state.

18. The ONU of claim 10, being configured to be in one of states of a third downstream ONU synchronization state machine that includes a hunt state, a tuning state, a stabilization state, and a locking state.
